(19) United States
(12) Patent Application Publication
(10) Pub. No.: US 2006/0050528 A1
(43) Pub. Date: Mar. 9, 2006

(54) Sign lighting system

(76) Inventors: Christopher L. Lyons, Sherman Oaks, CA (US); John P. English, Calabasas, CA (US)

Correspondence Address: BIRCH STEWART KOLASCH & BIRCH, PO BOX 747, FALLS CHURCH, VA, 22040-0747, US

(21) Appl. No.: 11/223,651

(22) Filed: Sep. 8, 2005

Related U.S. Application Data
(60) Provisional application No. 60/608,032, filed on Sep. 8, 2004.

(51) Int. Cl. F21V 5/00

(52) U.S. Cl. 362/559

(57) ABSTRACT

A real estate sign post having a crossbar on which a modular lighting unit is secured by two theft-resistant screws having non-circular holes in their heads and shielded by upstanding walls on mounting brackets. The lighting unit is enclosed in a box-like housing with a solar panel in the top side, slot-like lamp openings at opposite ends of the bottom side, and elongated arrays of LED's mounted in concave reflectors for directing light toward opposite sides of a real estate sign. Battery packs enclosed in shrink wrap and a controller are enclosed in the housing. An alternative embodiment mounts fluorescent bulbs in reflectors that are supported on opposite sides of a base unit by elongated arms.

### CROSS-REFERENCE TO RELATED APPLICATION

This Non-provisional application claims priority under 35 U.S.C. § 119(e) on U.S. Provisional Application No. 60/608,032 filed on Sep. 8, 2004, the entire contents of which are hereby incorporated by reference.

### BACKGROUND OF THE INVENTION

This invention relates to outdoor lighting systems, and more particularly to lighting systems for outdoor signs.

Although night lighting of signs such as roadway signs, motel signs and signs for various businesses is known, the technology for such lighting is relatively complex and expensive and usually required substantial time and effort for installation. One type of outdoor signs for which practical night lighting has not been provided is real estate signs of the type posted on properties indicating “For Sale” or “For Lease” status. These typically contain relevant listing information such as the names of the selling broker and/or agent, telephone numbers and the like, and are lighted only by sunlight during daylight hours.

Real estate signs typically comprise posts that are set into the ground in upright positions and have generally horizontal crossbars on which the real estate signs are suspended. The listing information is printed on one or both sides of the signs. Large numbers of such signs are installed on a regular basis throughout the United States and elsewhere, at very substantiated expense, and serve the very important function of attracting inquiries from potential buyers and renters.

### SUMMARY OF THE INVENTION

The present invention resides in a simple, inexpensive and very effective lighting system for outdoor signs, and particularly for real estate signs, that can be produced in modular form to be mounted quickly and easily on the typical post structure to illuminate a sign for an additional time period after natural light ceases. The lighting system is enclosed in an easily mounted housing and includes at least one, and preferably two, lighting assemblies positioned to illuminate one, or preferably two, sides of a sign, and a rechargeable energy system, preferably with a built-in solar-powered generator that provides energy for the lighting assemblies after darkness falls, preferably terminating the lighting after a sufficient length of time. The system includes one or more theft-resistant fasteners which hold the housing securely on the post and discourage theft or tampering by making removal of the housing difficult.

More specifically, the preferred embodiment comprises a flat, generally rectangular box-like housing sized and shaped to be secured to the top of the crossbar of the post structure, a solar generator comprising at least one solar cell assembly on top of the housing and at least one battery pack enclosed in the housing, and an electric control unit including a charging circuit for the battery pack or packs. The lighting assemblies are mounted in the opposite ends of the underside of the housing to lie over opposite sides of the sign, with reflectors that are shaped to direct light downwardly toward the sign. The preferred lamps for the lighting units are light-emitting diodes (LEDs) mounted in rows in elongated reflectors over slots in the housing.

The preferred fasteners are self-threading wood screws inserted through brackets on the sides of the housing and driven into the top of the crossbar, with heads on the screws shielded in protective recesses in the brackets. The heads have non-circular recesses in their ends for engagement with a non-circular driving tool, herein shown as generally triangular recesses for installation and removal by the tools that are not readily available to unauthorized people.

An alternative embodiment has two separate housings for lighting assemblies that are supported in inclined positions on laterally extending arms, with a third housing serving as a base unit that is secured to the crossbar of the sign post. In this instance, a single bolt is extended through the base unit and the crossbar with a nut threaded tightly on its lower end and recessed and concealed beneath the crossbar. The solar energy system components are housed in the base unit, and the lamps in this embodiment are fluorescent bulbs powered through a fluorescent ballast and driver in the base unit.

Other aspects and advantages of the invention will become apparent from the accompanying drawings and detailed description.

### BRIEF DESCRIPTION OF THE DRAWINGS

FIG. 1 is a side perspective view of a representative outdoor sign and sign post that equipped with a modular lighting system in accordance with the present invention;

FIG. 2 is an enlarged bottom plan view of the lighting system alone;

FIG. 3 is a cross-sectional view taken along line 3-3 of FIG. 2;

FIG. 4 is a top plan view of the lighting system alone;

FIG. 5 is an enlarged perspective view of a reflector alone;

FIG. 6 is a further enlarged cross-sectional view taken alone line 6-6 of FIG. 5;

FIG. 7A is a further enlarged fragmentary cross-sectional view taken at the left-hand end of FIG. 3, with a fastener shown in an exploded perspective view;

FIG. 7B is an enlarged side elevational view, partly in cross-section, of the theft-resistant fastener;

FIG. 8 is a top plan view of the theft-resistant fastener;

FIG. 9 is a top plan view of an alternative embodiment of the invention, with the position of a sign post crossbar shown in broken lines;

FIG. 10 is a partial side elevational view of the post and base unit of the alternative embodiment; and

FIG. 11 is a fragmenting bottom plan view of the alternative embodiment.

### DESCRIPTION OF PREFERRED EMBODIMENT

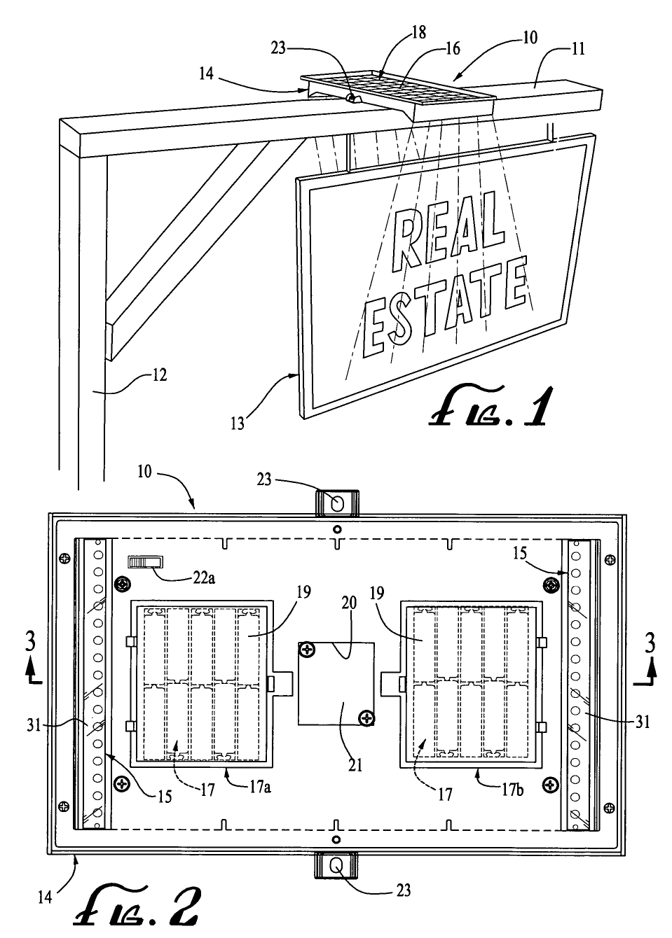

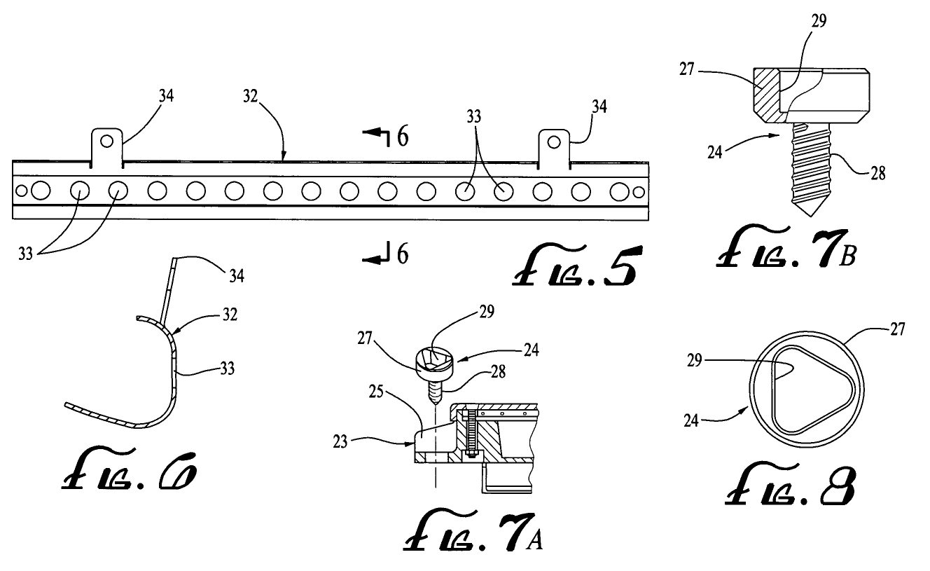

As shown in the drawings (FIGS. 1-8) for a purposes of illustration, the preferred embodiment comprises a modular lighting system, indicated generally by the reference number 10 in the drawings, that is mounted on a representative outdoor sign structure, typically a real estate sign advertising a piece of property for sale, rent or lease. Such signs typically are mounted on a generally horizontal crossbar 11 on an upright post 12 set in the ground, and typically are wood posts of rectangular cross-sectional shape. These sign posts have become substantially standardized in the real estate industry and display the usual brokerage and agents information on a both sides of a rectangular sign 13 that is suspended beneath the crossbar 11.

It has been the usual industry practice to leave such signs unlighted, other than by daylight or any other light source that might coincidentally be present on the site where the sign is posted. Accordingly, such signs are effective to display the information for which they are erected only during daylight hours and are generally ineffective during later hours after nightfall, despite the fact that potential customers often pass by the signs at these times.

The present invention is intended to provide a relatively simple, inexpensive and easily installed lighting system or unit 10 for outdoor signs, particularly real estate signs 13 of the foregoing kind, that will significantly increase the effectiveness of the signs in a commercially practical manner. For this purpose, the lighting system of the invention comprises a base or housing 14 that is mountable on a sign post structure, preferably on top of the crossbar 11 thereof, and provides one or more lighting assemblies 15 for the sign and an energy system for the lighting assemblies, preferably including one or more battery packs 17 and a solar-powered generator 18. The generator has solar cells that charge the batteries during daytime and thereby provide energy for the lighting assemblies after darkness. The system preferably terminates the lighting after a selected period of time, whether by discharging the batteries or by a shut-off timer in the energy system.

As shown most clearly in FIG. 1, 2 and 3, the preferred embodiment of the lighting system 10 has a housing 14 that is secured to the top of the crossbar 11 and is long enough to project laterally outwardly and position two assemblies 15 on the opposite ends of the underside of the housing to illuminate the two sides of the sign 13. The preferred housing has a length on the order of twelve to eighteen inches to reach substantially beyond the crossbar, and herein as shown as being about fifteen inches long. The housing is a thin and flat boxlike enclosure having generally rectangular top and bottom surfaces 14a and 14b, the width not being critical but, for compactness, preferably being in the range of four to ten inches. The thickness also is kept small for compactness, and may be on the order of one to two inches.

For optimum energy generation, the cells of the solar-powered generator 18 are mounted as a flat panel covering virtually the entire top surface of the housing 14, herein under an aperture at top wall 14 attached to the housing and defining a central opening 16 for the panel. Various solar cell panels are available for this purpose, being sold in large sheets that can be cut to size for this as needed. The representative panel is about fourteen inches by nine inches and rated at 12V, five Watts.

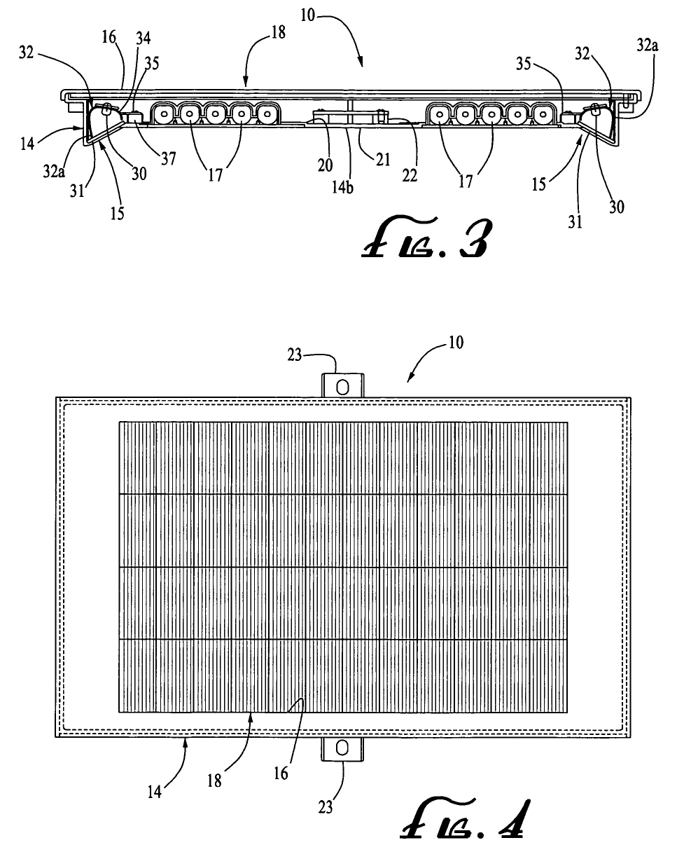

With two lighting assemblies 15, the lighting system 10 preferably has two battery packs 17 that are enclosed in the housing 14 in two interior compartments 17a and 17b, having openings in the underside 14b of the housing, normally closed by covers 19 that are removably secured to the housing. These covers are positioned to overlie the crossbar 11 in the mounted system, and thus are protected against unauthorized access. As shown in FIGS. 2 and 3, each pack 17 may comprise ten rechargeable battery cells, although more may be provided for greater storage capacity. Suitable batteries are AA rechargeable lithium or nickel hydrogen batteries.

Between the two battery compartments 17a and 17b is a third compartment having an access opening 20 on the underside 14b of the housing, normally closed by a removable cover 21, herein held in place by screws 21. This compartment houses an electrical controller 22 for the charging circuitry of the system. One suitable controller for this purpose is shown in U.S. Pat. No. 5,221,891, which is relatively inexpensive. Other controllers are available on the market and may be used, the important factors bring cost and reliability. The controller 22 is adapted to turn on the lighting system when daylight ceases. For shut-off after sufficient time in the evening, a timer (not shown) may be included in the controller 22, or the capacity of the battery packs may be selected simply to discharge after a suitable period, such as three to four hours of operation. An on-off switch 22a is provided in the circuitry of the controller.

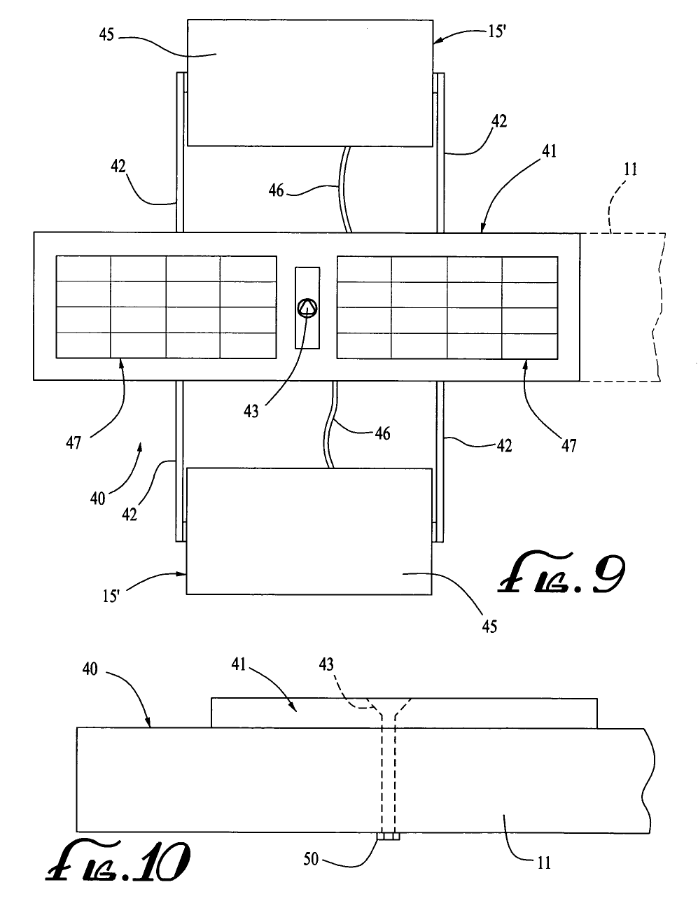

For theft-resistant mounting of the housing 14 on the sign post, at least one, and preferably two, mounting brackets 23 (see FIG.7A) are positioned on the housing to lie over the crossbar 11 and receive two special fasteners 24 that secure the housing to the crossbar. As shown in FIG. 7A, these brackets extend outwardly on opposite elongated side edges of the housing, midway between the lighting assemblies 15, and define holes for the fasteners 24 and protective, shielded seats 25 for the heads 27 of the fasteners. The brackets have upstanding sidewalls on opposite sides of the holes, to restrict access to the sides of the heads 27. The preferred fasteners are self-tapping wood screws having enlarged circular heads 27 to fit in the seats, threaded stems 28 to be driven into the crossbar 11, and non-circular recesses 29 in the heads for engagement with a special non-circular tool (not shown) for installation and removal. Herein, the tool recesses 29 are generally triangular in cross-sectional shape, but other shapes may be used. This mounting does not guarantee against theft or vandalism but discourages casual removal of the housing from the post structure. One mounting screw may be adequate, but two are more secure.

Highly effective and practical lighting is provided in the preferred embodiment by the two elongated lighting assemblies 15 extending across the opposite end portions of the underside 14b of the housing 14 and utilizing an array of LEDs 30 (FIG. 3) as the light source in each assembly. Each assembly is positioned over a narrow, slot-like opening in the underside of the housing and covered by a downwardly inclined glass or plastic transparent pane 31. Above the pane 31 is a reflector panel 32 that is of concavely curved, cross-sectional shape and has a longer outer side 32a that tilts the axis of reflection toward the sign 13. The LED's are mounted in a row of holes 33 in the top of the reflector and tilted slightly toward the longer outer side, herein constituting a row of sixteen LED's, although different numbers may be provided for different lighting intensity. The preferred embodiment provides very effective intensity. The reflector 32 has mounting tabs 34 that are secured by screws 35 to posts 37 on the bottom wall 14b. This holds the reflectors securely in place.

With a lighting system of the foregoing type, all of the necessary and desirable components are compactly mounted in a reusable and simple modular unit that can be produced relatively inexpensively and mounted simply and easily on a real estate or other sign post for use as needed. The theft-resistant mounting provides reasonable security, and the solar generator and rechargeable batteries provide an effective energy system, the batteries preferably being packaged as shrink-wrapped packs for ease of handling and replacement as needed. The LED lamps provide excellent light at a very reasonable cost.

### DESCRIPTION OF THE ALTERNATIVE EMBODIMENT

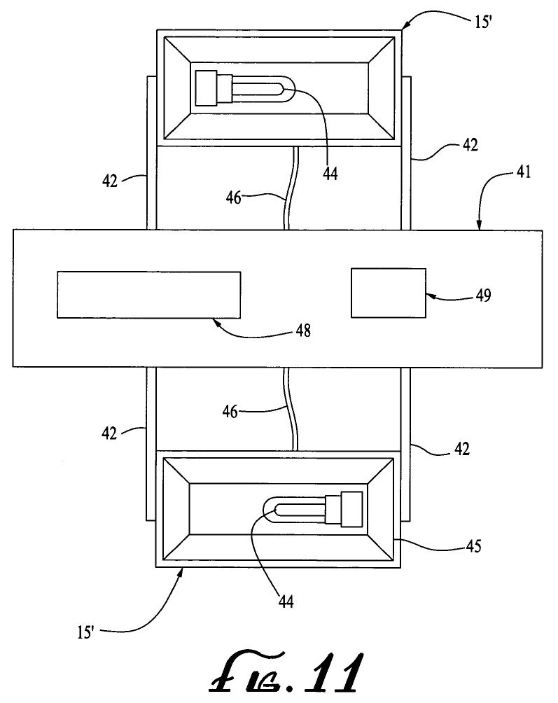

An earlier version and alternative embodiment of the invention is shown in FIGS. 9, 10, and 11, having two lighting assemblies 40 supported on opposite sides of a central base unit 41 on laterally extending arms 42, the base unit being secured to the crossbar 11 of a sign post by a fastener 43. In this embodiment, the lighting assemblies 15′ comprise fluorescent bulbs 44 in reflectors 45 connected to the base unit 41 by exposed wires 46, and two solar generators 47 are mounted on top of the base unit and connected to a battery pack at 48 in the base unit, which also houses a controller at 49 for the electrical circuits. In this embodiment, the fastener 43 is an elongated bolt whose head is recessed into the top of the base unit 41, and extending through the crossbar to a nut 50 that is concealed on the underside of the crossbar. The head may be made theft resistant in the same manner as in the first embodiment, or may simply be difficult to access.

It will be apparent that the alternative embodiment is larger, bulkier and less integrated than the preferred embodiment, but has the basic elements and capabilities of the first, preferred embodiment. The common components that are not shown in detail herein may be the same as in the preferred embodiment.

From the foregoing, it will be apparent that the present invention provides a practical outdoor lighting system for real estate signs and the like, that will illuminate such signs effectively for much longer periods of use. It also will be apparent that, while two embodiments have been illustrated and described, various modifications and changes may be made by those skilled in the art without departing from the invention.

We claim as our invention:

1. In combination with a real estate sign post having a generally horizontal crossbar composed of wood, and a sign depending from the crossbar and containing real estate information, an outdoor lighting system, comprising:
a box-like housing having generally rectangular top and bottom sides and narrow side edges, said housing being disposed on said crossbar and having opposite end portions spaced laterally from the crossbar, an opening in said top side, and elongated slot-like openings in the underside of said opposite end portions extending across said end portions;
two elongated lighting assemblies disposed in said housing above said slot-like openings and each comprising an elongated reflector and a plurality of LEDs arranged in a row along the reflector to produce light, said reflector being concave in cross-section and positioned to focus the light from the LEDS on the sign;
at least one battery pack in said housing containing at least one rechargeable battery for providing electrical energy to said LEDs;
a solar generator having a flat panel of solar cells disposed in said opening in said top side for exposure to sunlight during daylight hours to charge the battery pack;
a controller in said housing for controlling the charging of the battery pack during daylight hours and providing energy to the LEDs during darkness;
and at least one theft-resistant fastener securing said housing to the crossbar and discouraging unauthorized removal of the lighting system from the post;
whereby the real estate sign is lighted by the lighting system during darkness and is recharged during daylight hours.

2. The combination defined in claim 1 wherein said theft-resistant fastener is a screw having a head with a non-circular recess in the end of the head, said recess being specially shaped for driving engagement with a non-circular driving tool.

3. The combination claimed in claim 2 wherein said housing is formed with at least one mounting bracket thereon that overlies said crossbar and is formed with a hole through which said fastener extends, said fastener having a threaded stem set in the crossbar and said bracket having a shield around said head restricting access to the side of said head.

4. The combination defined in claim 3 wherein there are at least two of said fasteners and at least two of said mounting brackets, disposed between said opposite ends of said housing.

5. The combination defined in claim 1 wherein there are two battery packs each comprising a plurality of batteries, one pack for each lighting assembly, and the batteries of each pack are enclosed in shrink wrap for ease of handling.

6. The combination defined in claim 1 wherein there are two battery packs, each disposed in a compartment in said housing, and said housing has removable covers for said compartments disposed between said crossbar and said housing.

7. The combination defined in claim 1 further including two transparent panes covering said slot-like openings for said lighting assemblies, each of said panes being inclined downwardly from the underside of said housing to direct light toward the sign.

8. The combination claimed in claim 7 wherein said reflectors are concavely curved in cross-sectional shape and have said LEDs mounted in a row along their top sides, the reflectors being shaped to direct light toward the sides of the sign.

9. An outdoor lighting system for a sign hanging below a generally horizontal crossbar, comprising:
a box-like housing to be disposed on the crossbar and having a top surface formed with an opening;
a solar generator having a solar panel mounted in said opening;
two lighting assemblies supported by said housing to lie on opposite sides of said crossbar and illuminate opposite sides of the sign;
a battery pack in said housing containing at least one rechargeable battery and connected to said generator to be charged thereby;
a controller for connecting the battery pack to the lighting assemblies to provide energy after dark and to the generator to recharge the battery pack during the daylight hours;
and at least one fastener for securing the housing to the crossbar.

10. A lighting system as defined in claim 9 wherein said fastener is a theft-resistant fastener having a head with a non-circular opening for engagement with a non-circular tool.

11. A lighting system as defined in claim 9 wherein said lighting assemblies are mounted in said housing adjacent opposite ends thereof, and include reflectors for directing light toward the sign.

12. A lighting system as defined in claim 9 wherein each lighting system contains a plurality of LEDs as a light source.

13. A lighting system as defined in claim 9 wherein said lighting assemblies are spaced from said housing to lie on opposite sides of the sign, and each is supported on two laterally extending arms secured to the housing.

14. A lighting system as defined in claim 13 wherein each such lighting system comprises a reflector and a light source in the reflector.

15. A lighting system as defined in claim 14 wherein the light source is a fluorescent bulb.

16. A lighting system as defined in claim 9 wherein said fastener is a bolt having a head above said housing and a stem for extending through the crossbar, and a nut threaded onto the bolt to lie beneath the crossbar.

17. An outdoor lighting system comprising:
a box-like housing having one side having an opening, a second side having at least one slot-like opening, and at least one inner compartment;
a solar generator having a solar panel disposed in said opening in said one side to be exposed to the sun during daylight hours;
a lamp assembly mounted in said housing within said slot-like opening;
and at least one battery pack disposed on said compartment to be charged by the solar generator during daylight hours and to provide energy to said lamp assembly after dark.

18. An outdoor lighting system as defined in claim 17 wherein said lamp assembly is an elongated array of LEDs, and a reflector in said housing for directing light through said slot-like opening.

19. An outdoor lighting system as defined in claim 18 wherein said second side of said housing is elongated and has an elongated slot-like opening extending across each end, and including one of said lamp assemblies within each slot-like opening.

20. An outdoor lighting assembly as defined in claim 17 further including at least one theft-resistant fastener for securing said housing to a supporting crossbar, said fastener having a head of circular cross-sectional shape, a threaded stem to extend into a crossbar, and a non-circular recess in the end of said head for engagement with a non-circular tool.

21. An outdoor lighting assembly as defined in claim 20 wherein said housing has at least one mounting bracket having a hole through which the fastener extends, said bracket having a shield for substantially surrounding said head and limiting access to the side thereof.

22. An outdoor lighting system as defined in claim 20 wherein said fastener is a bolt having a stem for extending through a crossbar, and a nut threaded onto the end of the bolt.

23. An outdoor lighting system as defined in claim 20 wherein said fastener is a self-tapping wood screw.
